(19) United States
(12) Patent Application Publication
(10) Pub. No.: US 2015/0012748 A1
(43) Pub. Date: Jan. 8, 2015

(54) Method And System For Protecting Data

(71) Applicant: Goertek, Inc., Weifang City, ShanDong Province (CN)

(72) Inventor: Binbin Jiang, Weifang City (CN)

(21) Appl. No.: 14/371,604

(22) PCT Filed: Jan. 17, 2013
(86) PCT No.: PCT/CN2013/070599

§ 371 Date: Jul. 10, 2014

(30) Foreign Application Priority Data
Jan. 19, 2012 (CN) 201210017522.3

(51) Int. Cl. G06F 21/62

(52) U.S. Cl. CPC G06F 21/6218; G06F 2221/2107
USPC 713/168

(57) ABSTRACT

Disclosed are a method and a system for protecting data. The method for protecting data provided by an embodiment of the present invention comprises: in an initialization process of a device where data are located, acquiring an environmental factor according to environment information of the device in a secure environment; and encrypting sensitive data in the device by utilizing the environmental factor in the secure environment, and after determining that the encryption succeeds, destroying the environmental factor. Each time the device is started, an environmental factor is acquired according to the environment information of the device in the current environment, and then the encrypted sensitive data in the device is decrypted by utilizing the environmental factor in the current environment; when the decryption succeeds, access to the data in the device is allowed, and when the decryption fails, access to the data in the device is denied. The hardware cost required by the solution is low, and the risk of data leakage can be greatly reduced.

### TECHNICAL FIELD

The present application relates to the technical field of data security, particularly to a method and system for protecting data.

### BACKGROUND ART

With the popularity of information carrier devices, more and more automatic control and information processing systems use an embedded architecture, and the dependence of individuals and social organizations such as businesses on information carrier devices is also becoming increasingly higher. Embedded device is a common information carrier device. Popularity of embedded device, on one hand, improves the productivity of society and facilitates the control to production, and on the other hand, raises specific requirements on protecting the security of a variety of information recorded in the system.

In recent years, many information security firms confine their research and development on data protection technology to how to protect the security of data of embedded devices in the network, such as the protection of data like database and local files in the network. The security of the data in an embedded device itself that serves as a carrier for storing and managing information (especially the physical security of the device) is often overlooked, leading to a higher risk of data leakage and difficulty in achieving real security and reliability. Especially for embedded mobile devices, once they are lost or maliciously stolen, the data in the devices can be easily leaked, resulting in loss of an enterprise's core data, which may lead to losses of enterprise technology and business secrets.

At present, many developers and users are beginning to realize the value of data in business and in enterprise value chain. With regard to the above problem, it is proposed to protect information carrier devices using a trusted computing theoretical system. In hardware, an encryption hardware device, such as TPM (Trusted Platform Module) chip and USB-key, is added; and logically, a credible security root is set up, which can be considered as a “root” of trust relationship in a security system and serves as a basis for all activities that trust or authorize mutually in the security system.

The existing data protection solutions have at least the following shortcomings:

The existing trusted computing theoretical system solutions require additionally disposing an encryption hardware device, such as TPM chip or USB-key, on the computing platform, so the hardware cost is too high and it is difficult for the majority of users to accept it. In addition, the operation of implementation and deployment of the existing security protection system is complicated and of high degree of specialization, and common IT managers often have difficulty in independently accomplishing the configuration and maintenance of the system because once an error occurs in the configuration, the entire system will be unusable or the security of the entire system will be greatly reduced.

### SUMMARY OF THE INVENTION

The present invention provides a method and system for protecting data to address the problem of high hardware cost and high degree of specialization in the existing solution.

To achieve the above object, an embodiment of the present invention adopts the following technical solution:

An embodiment of the present invention provides a method for protecting data, comprising: in an initialization process of a device where data are located, acquiring an environmental factor according to the environment information of the device in a secure environment; and encrypting sensitive data in the device using the environmental factor in the secure environment, and destroying the environmental factor after determining that the encryption succeeds; and
acquiring, every time the device is started, an environmental factor according to the environment information of the device in the current environment, and then decrypting the encrypted sensitive data in the device using the environmental factor in the current environment; access to the data in the device is allowed if the decryption succeeds, and access to the data in the device is denied if the decryption fails.

Another embodiment of the present invention provides a system for protecting data, the system comprising a device where data are located, the device comprising an initialization unit, a boot control unit, an environmental factor acquisition unit and an encryption and decryption unit, wherein
in an initialization process of the device, the initialization unit acquires an environmental factor according to the environment information of the device in a secure environment via the environmental factor acquiring unit, and encrypts sensitive data in the device via the encryption and decryption unit using the environmental factor; the initialization unit destroys the environmental factor after determining that the encryption succeeds; and
every time the device is started, the boot control unit acquires an environmental factor according to the environment information of the device in the current environment via the environmental factor acquiring unit, and decrypts the encrypted sensitive data via the encryption and decryption unit using the environmental factor in the current environment; and the boot control unit allows access to the data in the device if the decryption succeeds, otherwise, it denies access to the data in the device.

The beneficial effects of the embodiments of the present invention are:

In the embodiments of the present invention, by means of extracting a secure environmental factor from a secure environment and encrypting non-volatile sensitive data in the device using the secure environmental factor, the sensitive data in the device can be bound to a work environment. The environmental factors extracted from different work environments are different, so once the device is removed from a secure work environment, decryption will fail due to failure in acquiring a consistent environmental factor, thereby reducing the risk of data leakage by denying the access to the data in the device. Since the protection of non-volatile sensitive data in a device is realized by an encryption and decryption mechanism bound to the environment without need of additionally disposing an additional encryption hardware device, the hardware cost is low. In addition, operation of the implementation and deployment of this data protection solution is relatively simple and does not require high degree of specialization, so the workload in implementing and deploying the system and the requirement in human resources are reduced.

### BRIEF DESCRIPTION OF THE DRAWINGS

FIG. 1 is a flowchart of the method for protecting data provided by an embodiment of the present invention.

FIG. 2 is a schematic view of the working manner of the environmental factor acquisition unit provided by another embodiment of the present invention.

FIG. 3 is a schematic view of the working manner of the system for protecting data provided by a further embodiment of the present invention.

FIG. 4 is a schematic view of the working manner of starting a dual-system device that is bound to the environment provided by a further embodiment of the present invention.

FIG. 5 is a schematic diagram of the dual-system operation mechanism provided by a further embodiment of the present invention.

### DETAILED DESCRIPTION OF THE INVENTION

To make the object, technical solution and advantages of the present invention clearer, the embodiments of the present invention are described in further detail with reference to the drawings.

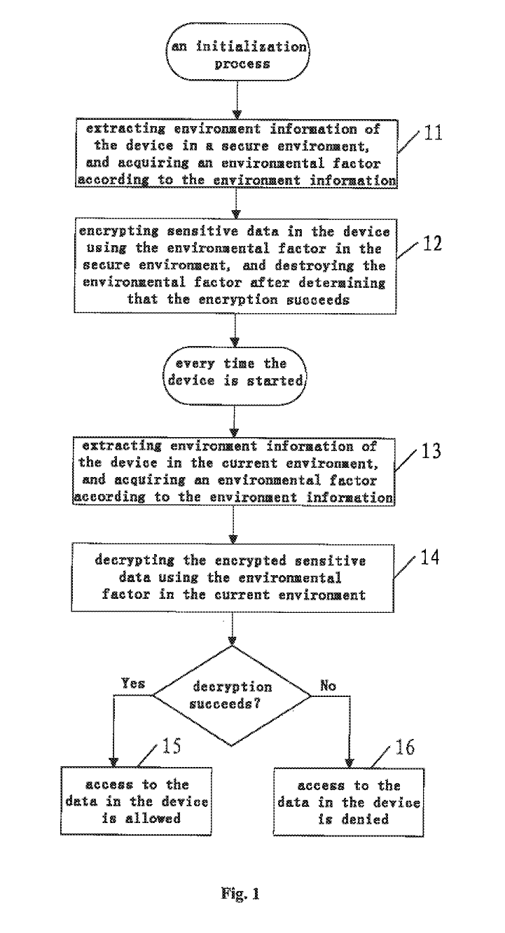

An embodiment of the present invention provides a method for protecting data (see FIG. 1), comprising:

11: Extracting the environment information of a device in a secure environment (“secure environment information” for short), and acquiring an environmental factor according to the secure environment information.

The device is the one where data needing protection are located.

12: Encrypting sensitive data in the device using the secure environmental factor, and destroying the environmental factor after determining that the encryption succeeds.

The secure environment may be a work environment where the device is installed for the first time, then the operation of steps 11 and 12 can be performed during the first initialization process of the device; or, the secure environment may be a work environment configured according to the actual needs after the initial installation and running of the device, then the operation of steps 11 and 12 is completed during an initialization process of the device.

The sensitive data are unique data indispensable for the access to the data of the device in a secure environment and are non-volatile data. For example, the sensitive data may be unique non-volatile data indispensable for starting the operating system of a device in a secure environment.

13: Extracting the environment information of the device in the current environment (“current environment information” for short) every time the device is started, and acquiring an environmental factor according to the current environment information.

In this embodiment, after the non-volatile sensitive data are encrypted using a secure environmental factor, the current work environment needs to be identified to extract a current environmental factor when the device is started again.

It is requested that the environmental factors extracted through the same work environment are consistent (or the error is within a certain tolerable range), and the environmental factors extracted through different work environments are different. The environmental factors for encrypting and decrypting non-volatile sensitive data need to be kept consistent.

14: Decrypting the encrypted sensitive data using the current environmental factor and determining whether the decryption succeeds; performing step 15 if the decryption succeeds and performing step 16 if the decryption fails.

15: Allowing access to the data in the device if the decryption succeeds.

For example, the operating system of the device in a secure environment is allowed to be started and run to achieve normal access to the data in the device.

16: Denying access to the data in the device if the decryption fails.

For example, the operating system of the device in a secure environment is forbidden to be started to prevent access to the data under this operating system.

Further, this embodiment also provides a mechanism of mutual authentication between an environment and a device, comprising: an environment monitoring server pre-collects the identity information of the device in a secure environment; and every time before the device is started,
the environment monitoring server collects the identity information of the device in the current environment, verifies the identity information of the device in the current environment according to the identity information of the device in the secure environment, and determines whether the device is legal according to the verification result; if it is, the device is allowed to access to a secure environment; and if not, the device is forbidden to access to a secure environment.

The specific performing manners of the concerned steps in the present method embodiments can refer to the related content in the system embodiment of the present invention.

The data protecting mechanism provided by the solution is described in another embodiment of the present invention with a system for protecting data as an example. The system for protecting data provided by this embodiment comprises a device where data are located, the device comprising an initialization unit, a boot control unit, an environmental factor acquisition unit and an encryption and decryption unit.

In an initialization process of the device, the initialization unit acquires an environmental factor according to the environment information of the device in a secure environment via the environmental factor acquiring unit, and encrypts sensitive data in the device via the encryption and decryption unit using the environmental factor; the initialization unit destroys the environmental factor after determining that the encryption succeeds.

Every time the device is started, the boot control unit acquires an environmental factor according to the environment information of the device in the current environment via the environmental factor acquiring unit, and decrypts the encrypted sensitive data via the encryption and decryption unit using the environmental factor in the current environment; and the boot control unit allows access to the data in the device if the decryption succeeds, otherwise, it denies access to the data in the device.

The secure environment may be a work environment where the device is installed for the first time, or, the secure environment may be a work environment configured according to the actual needs after the initial installation and running of the device. In this embodiment, the work environment where the device is installed initially is selected as an example of a secure environment. The device includes, but are not limited to, various embedded devices, such as embedded storage device, embedded handheld device (mobile phone, Pad), embedded industrial control computer.

Extraction of an Environmental Factor

Extraction of an environmental factor refers to the process during which the device (e.g. an embedded device) being protected interacts with its work environment (including natural environment, physical environment of the device, server and software environment) via an environment information extraction unit according to a certain logic to complete extraction of characteristics from the environment information and finally generate a data string with a certain length as an environmental factor.

The interaction manner between the environment information extraction unit and the environment varies with the environment factor to be identified. The adoptable interaction manner at least comprises: accurately measuring temperature environment, measuring light intensity, capturing image of physical environment via a video monitor, measuring biometric, measuring network environment, scanning data, acquiring a key by interacting with the Internet by means of Challenge-Response authentication mechanism, and so on. The interaction of any one of these factors or combination of any of them finally forms an environmental factor for the system to cognize environment.

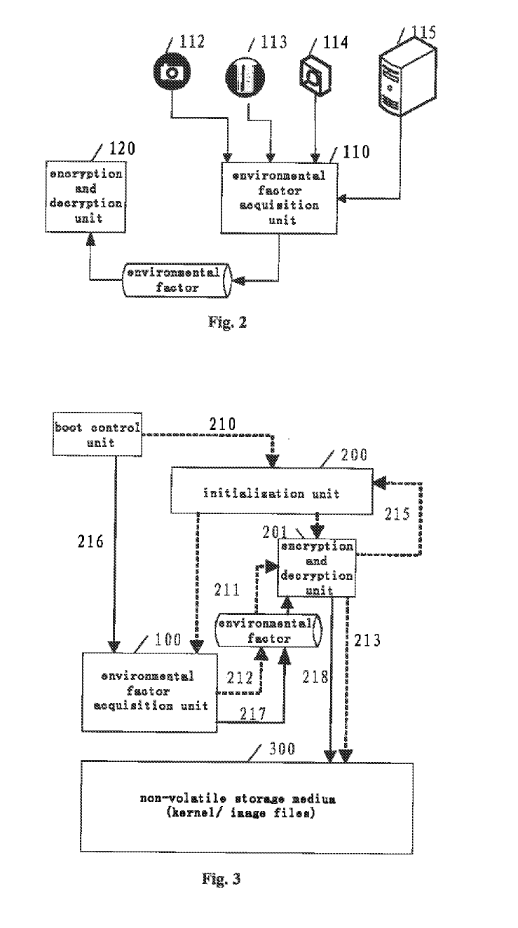

Referring to FIG. 2, the environmental factor acquisition unit 110 interacts with the external devices 112-115 for extracting environment information that are environment information extraction units.

Image collector 112 can collect physical environment image information the physical environment of the device corresponds to, and the extracted environment information comprises the physical environment image information.

Temperature and humidity collection device 113 (e.g., temperature collector) can acquire temperature environment information by measuring the temperature environment of the device, and the extracted environment information comprises the temperature environment information.

Temperature and humidity collection device 113 (e.g., humidity collector) can also acquire humidity environment information by measuring the humidity environment of the device, and the extracted environment information comprises the humidity environment information.

Both the image collector 112 and the temperature and humidity collection device 113 can collect data through a direct data interface, and then a stable and reliable value is obtained through a data error elimination mechanism as an environmental factor or to participate in the generation of an environmental factor.

Network detection server 114 can collect network environment information of the network environment of a device, and the extracted environment information comprises the network environment information. Network detection server 114 is realized by functional sub-modules integrated within an embedded device or by a device positioned outside the embedded device. The collected network environment information mainly comprises network topology and FingerPrint of various servers or a specific host in network, such as the address information of media access control (MAC). The information is abstracted to form an environmental factor or participate in the generation of an environmental factor.

Mutual identity authentication is performed between authentication server 115 and the device. After the authentication, the authentication server generates a data block as mutual identity authentication information. The data block is sent to the device, so the extracted environment information comprises the data block. For example, the authentication server 115 and an embedded device can directly perform channel mutual authentication by a challenge-response asymmetric encryption method, meanwhile the authentication server and the embedded device identify each other's identity, and then the authentication server issues a data block to the embedded device in the asymmetric encryption data channel to serves as an environmental factor or participates in the generation of an environmental factor. Therein, challenge-response authentication mechanism is a manner of identity authentication. In this manner, authentication server side sends a different “challenge” string to the client side in every authentication, and the client side makes a corresponding “response” after receiving this “challenge” string so as to realize the identification of the identity of them.

Further, in addition to the measurement of the environmental factors, this system can also measure the light environment of a device with a light collector to acquire light intensity information, and the extracted environment information comprises the light intensity information; or, this system can collect the biometric information (such as fingerprint, iris, etc.) of the user of the device with a biometric collector, and the extracted environment information comprises the biometric information.

Environmental factor acquisition unit 110 directly takes one or more pieces of extracted environment information as an environmental factor acquired; or, the environmental factor acquisition unit uses one or more pieces of extracted environment information to generate an environmental factor. For example, the environmental factor acquisition unit extracts the characteristic of one or more pieces of environment information and generates a data string with a certain length according to a predetermined algorithm as an environmental factor. An environmental factor may be generated, for example, by means of extracting the characteristics of the specific data of environmental variables in the environment information, forming a characteristic string after shielding microscopic variables, performing hash operation of all characteristic strings corresponding to respective environment variable data that are involved in the computation, and finally acquiring an environmental factor. Or, an environmental factor can be acquired by the method of modulo operation of characteristic strings. Environmental factor acquisition unit 110 sends the environmental factor to an encryption and decryption unit 120, and the encryption and decryption unit 120 takes the environmental factor as a key for the encryption or decryption of non-volatile sensitive data.

Initialization Unit

The initialization unit mainly completes the recognition of environment information and extraction of environment information when the device is installed for the first time, the formation of an environmental factor, and the encryption of the sensitive data on the non-volatile storage medium of a system with this “environmental factor” as the key for initialization. The non-volatile sensitive data are unique data indispensable for the access to the data of the device in a secure environment. For example, the non-volatile sensitive data may be unique data indispensable for starting the operating system of a device in a secure environment. For an embedded device, the selected non-volatile sensitive data is kernel and image file data (the data in Ramdisk memory disk). For other data on the non-volatile storage medium of a device, encryption process is realized at the operating system level using the environmental factor by means of pre-sharing a key to complete the transfer of credibility.

The initialization unit can be logically in the application layer of the system and works when the system is started for the first time, and it operates the environmental factor acquisition unit and the encryption and decryption unit respectively to complete the first running configuration of the system. No savable configuration file or data is generated during the configuration process, but an environmental factor is acquired by extracting the result of environmental data characteristic. The environmental factor is used as a key to directly encrypt the kernel and image files of the system that need to be protected. The environmental factor will not be saved if the encryption succeeds. The result of the initialization cannot be directly extracted and reversely analyzed.

In this embodiment, the initialization unit has a self-destruction function for destroying secure environmental factors, removing the unencrypted non-volatile sensitive data stored in the device and prohibiting the encryption function after determining that the encryption succeeds. Data erasing operation is performed in the data storage space occupied by the initialization unit on the storage medium of the system. The method of erasing comprises filling all with zero, filling all with 1, and filling with a random number. At the final stage of self-destruction process, the configuration file of the boot control unit is amended, the information related to the initialization unit is removed, and the device is restarted.

Boot Control Unit

The boot control unit mainly completes the confirmation of environment before the system is started and execution of the action of environment confirmation before the guidance of the operating system kernel of an embedded device, to prevent starting the device in an environment without a security protection system (e.g., removing the device out of a specified running environment).

Therefore, the boot control unit can realize the generation of an environmental factor by calling the same environmental factor acquisition unit. Similarly, the generated output result (an environmental factor) is a decryption key for only one-time use and will not be saved in the system.

Firstly, the environmental factor acquisition unit extracts an environmental factor according to the acquired environment information to decrypt the operating system kernel and its corresponding image file (Ramdisk) that are stored in the non-volatile storage medium of the device. If the work environment of the device is changed, no correct environmental factor will be generated, and thus plaintext extraction operation cannot be performed to the data stored in the non-volatile storage medium.

In the same environment, the environmental factors extracted by the environmental factor acquisition unit should be fully consistent, and the environmental factors function only when the system is being loaded or started and will not be present in any volatile or non-volatile storage medium of the system once the system has been loaded or started.

Referring to FIG. 3, it shows a schematic view of the working manner of the system for protecting data provided by another embodiment of the present invention.

In this embodiment, the device to be protected is an embedded device, and the secure environment is an environment where the device is installed for the first time. During the initialization process, environment information is extracted and an environmental factor is generated. The kernel and image files of a ciphertext are generated during the initialization process using the environmental factor. Therefore, the initialization process must be one-off and irreversible. The initialization unit completes the operation when the system is powered-up for the first time, and after the operation, it must self-destruct to ensure the irreversibility of the initialization process.

When the system is started for the first time, the boot control unit can checks according to the configuration file of the system whether it is the first time that it is started; if it is, step 210 is performed.

210: Starting the initialization unit 200 of the system.

Initialization unit 200 calls environmental factor acquisition unit 100 to collect environment information and form an environmental factor, and inputs the environmental factor to encryption and decryption unit 201.

Step 213: Encryption and decryption unit 201 encrypts the kernel files and image files on the non-volatile storage medium 300.

In this embodiment, the non-volatile sensitive data selected from the device are encrypted by means of bitwise symmetric algorithm. Since it is a bitwise operation, the length of the raw data will not be changed after the encryption. So, the length of the original file will not be affected, which ensure the stability of the operating system and improves the compatibility of the device.

Encryption and decryption unit 201 will verify the encrypted kernel files and image files after the encryption operation. Upon the verification, initialization unit 100 will be notified to move forward into the next step 215 after determining that the encryption succeeds.

Step 215: Initialization unit 200 performs self-destruction operation.

Specifically, Self-destruction operation may be data erasing operation performed in the initial data storage space of the initialization unit 200.

The method of erasing data comprises filling all with zero, filling all with 1, and filling with a random number. The final stage of self-destruction process is to amend the configuration file of the boot control unit, remove the information related to the initialization unit 200, and thus the initialization process of the device is completed.

The step shown by dashed lines in FIG. 3 are steps necessary for the initialization of the device. Having been initialized, the system is powered up again to start the device and implement the steps shown by solid lines in FIG. 3. Step 216: The boot control unit enters normal starting process and calls directly the environmental factor acquisition unit 100 after the BIOS loads.

Step 217: Environmental factor acquisition unit 100 generates an environmental factor of the current environment and input it to the encryption and decryption unit 201.

Step 218: Encryption and decryption unit 201 decrypts and load the kernel and image files of the ciphertext using the environmental factor of the current environment. The access to the data of the device is allowed if the decryption succeeds, and denied if the decryption fails.

In this embodiment, after the device is removed from a secure environment and started, a variety of related operations can be used, e.g., sending alarm information using an alarm communication module (the alarm information may be GPS information, SMS, MMS and other information and may be sent out by a variety of network communication means); destroying the sensitive data using a remove module to prohibit access to the data in the device; or, using a startup prohibition module to prevent the device from starting the operating system in a secure environment to deny the access to the data in the device; and using a startup allowing module to allow the device to start the operating system in a non-secure environment when the decryption of the encryption and decryption unit fails (the operating system in a non-secure environment cannot access to the sensitive data).

A further embodiment of the present invention provides a dual-system device that selects different operating system according to environmental factors to start. That is to say, the system is provided with at least two operating systems, one of which is bound to environmental factors, and the other is an operating system that is not bound to the environment. The different operating systems can be flexibly switched as needed.

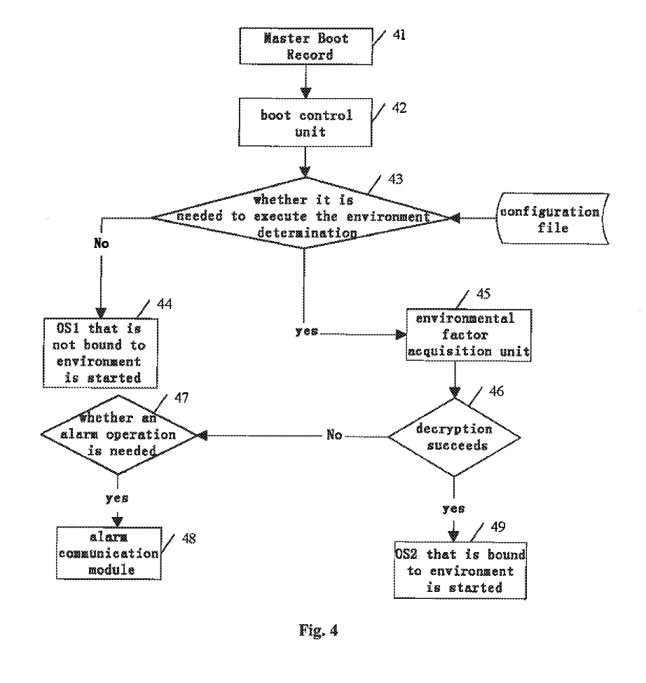

Referring to FIG. 4, after the non-volatile sensitive data in the device is encrypted using an environmental factor, a working process of starting the dual-system device provided by an embodiment of the present invention comprises:

Step 41: After the device is powered up, the MBR (Master Boot Record) is performed.

Step 42: The MBR starts the boot control unit.

The MBR loads the data of the boot control unit from the non-volatile storage medium to the memory and executes them.

Step 43: the boot control unit will determine according to the system configuration file whether it is needed to execute the environment determination process; if it is not, step 44 is performed; and it is, step 45 is performed.

Step 44: When it is not needed to execute the environment determination process, the first operating system (indicated as OS1) that is not bound to environment is started. The first operating system does not need access to the encrypted non-volatile sensitive data, that is, the first operating system can be started and run without the encrypted non-volatile sensitive data.

Step 45: When it is needed to execute the environment determination process, the environmental factor acquisition unit is started.

The environmental factor acquisition unit will generate an environmental factor according to the environment information acquired.

Step 46: The encryption and decryption unit executes the decryption operation to the kernel files and image files of a ciphertext according to the environmental factor. After determining that the decryption succeeds, step 49 is performed, the decrypted kernel files and image files are loaded, and the second operating system (indicated as OS2) that is bound to environmental factors is started. If the decryption fails, step 47 is performed.

Step 47: Determine whether an alarm operation is needed. If it is, step 48 is performed. When necessary, the non-volatile sensitive data can be destroyed to ensure that the device will not be started under the operating system that is bound to environment so as to deny the access to the data of the device under this operating system.

Step 48: Starting the alarm communication module and sending alarm information.

The alarm communication module may be one or more of SMS card, MMS card, or global positioning system (GPS) chip.

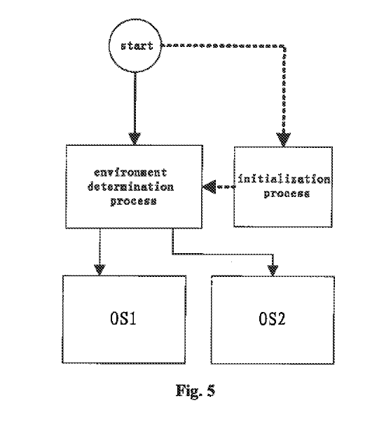

The dual-system operation mechanism provided by this embodiment can also be as shown in FIG. 5.

During the initialization process, initialization unit 200 selects one operating system from the two operating systems that the device supports to bind to environmental factors, e.g., binding operating system OS2 to environment.

When the device is restarted, the boot control unit determines directly through the environment confirmation process whether the device works under a secure environment. If it does, the operating system (OS2) under a secure environment is started; and if it does not, the other operating system (OS1) that is not bound to environment is started.

Further, this embodiment also provides a mechanism of mutual authentication between an environment and a device to ensure that the system has higher security. On the one hand, the device and an environment are bound using an environmental factor, and the device is required to be started in a secure environment; on the other hand, the environment can also identify the identity of the device working therein and only allows the devices of legal identity to work therein. In this case, this system further comprises an environment monitoring server that pre-collects the identity information of a legal device in a secure environment and stores it.

Every time before the current device is started, the environment monitoring server collects the identity information of the device in current environment and determines according to the identity information of the device in a secure environment whether the current device is a legal device; if it is, the device is allowed to access to a secure environment; and if not, the device is forbidden to access to a secure environment. The environment monitoring server can be realized by a singer server or realized by integrating in an embedded device.

The above processing manner not only requires the embedded device to be protected to determine in a certain way that itself is in a secure environment, but also allows the defined secure environment to ensure by a certain method (such as mutual authentication and device video surveillance, etc.) that all of the devices present in the environment are devices permitted by the environment, rather than other devices or logical units that are implanted randomly or invade. PKI (Public Key Infrastructure) authentication mechanism can be used between an environment monitoring server and an embedded device. PKI mechanism is key management technology that follows established standard and is a management system capable of providing all network applications with password services such as password encryption and digital signature and necessary key and certificate. The environment monitoring server and the embedded device mutually identify whether the certificate of the counterpart is valid. If the identification of one party fails, it can be considered that the embedded device is not a legal secure device and the operation of the embedded device is not allowed.

In this solution, all of the initialization unit, the boot control unit, the environmental factor acquisition unit, the encryption and decryption unit, and the alarm communication module can be realized by means of a hardware device. This solution simply uses “unit” and “module” as a name of a hardware device to cover a variety of hardware devices that can realize these units and modules. For example, the encryption and decryption unit in this solution can be realized by an encryption and decryption chip, e.g., HS32U1 system-level encryption chip; the alarm communication module in this solution can be realized by a SiRF III GFS chip when alarming by means of GPS and can also be realized by a SMS card (e.g. WAVECOM M 1206B) when alarming by means of SMS.

From the above, in the embodiments of the present invention, by means of extracting a secure environmental factor in a secure environment and encrypting non-volatile sensitive data in a device using the secure environmental factor, the sensitive data in the device can be bound to the work environment. The environmental factors extracted from different work environments are different, so once the device is removed from a secure work environment, the decryption will fail due to the failure in acquiring a consistent environmental factor, thereby reducing the risk of data leakage by denying the access to the data in the device. Since in this solution the protection of non-volatile sensitive data in a device is realized by an encryption and decryption mechanism bound to the environment without need of additionally disposing an additional encryption hardware device in this solution, the hardware cost is low. In addition, operation of the implementation and deployment of this data protection solution is relatively simple and does not require high degree of specialization, so the workload in implementing and deploying the system and the requirement in human resources are reduced.

The foregoing is only preferred embodiments of the present invention, which is not intended to limit the scope of the present invention. Any modification, equivalent replacement and improvement within the spirit and principle of the present invention shall be included in the protection scope of the present invention.

1. A method for protecting data, comprising: in an initialization process of a device where data are located, acquiring an environmental factor according to environment information of the device in a secure environment; and encrypting sensitive data in the device using the environmental factor in the secure environment, and destroying the environmental factor after determining that the encryption succeeds; and
acquiring, every time the device is started, an environmental factor according to the environment information of the device in the current environment, and then decrypting the encrypted sensitive data in the device using the environmental factor in the current environment; allowing the access to the data in the device if the decryption succeeds, but denying the access to the data in the device if the decryption fails.

2. According to the method of claim 1, wherein the environment information comprises at least one of the following:
temperature environment information of the device, humidity environment information of the device, light environment information of the device, biometric information of the user of the device, physical environment image information of the device, network environment information of the device, mutual identity authentication information for mutual identity authentication of the device and an authentication server;
acquiring an environmental factor according to the environment information comprises: using the extracted environment information as an environmental factor; or generating an environmental factor using the extracted environment information.

3. According to the method of claim 1, wherein
encrypting sensitive data in the device using the environmental factor in a secure environment comprises: encrypting sensitive data in the device by means of bitwise symmetric algorithm using the environmental factor in a secure environment;
decrypting the encrypted sensitive data in the device using an environmental factor in the current environment comprises: decrypting the encrypted sensitive data by means of the same bitwise symmetric algorithm as used for encrypting, using the environmental factor in the current environment.

4. According to the method of claim 1, wherein denying access to the data in the device when decryption fails comprises:
denying access to the data in the device by destroying the sensitive data; or,
denying access to the data in the device by preventing the device from starting the operating system in a secure environment.

5. According to the method of claim 4, wherein when denying access to the data in the device, the method further comprises:
sending alarm information; and/or
allowing the device to start the operating system in a non-secure environment, the operating system in a non-secure environment cannot access to the sensitive data.

6. According to the method of claim 1, wherein an environment monitoring server pre-collects the identity information of the device in a secure environment, and every time before the device is started,
the environment monitoring server collects the identity information of the device in current environment, determines the identity information of the device in current environment according to the identity information of the device in a secure environment, and determines according to the determination result whether the device is a legal device; if it is, the device is allowed to access to a secure environment; and if not, the device is forbidden to access to a secure environment.

7. According to the method of claim 1, wherein
the sensitive data are kernel and image file data when the device is an embedded device.

8. A system for protecting data, wherein the system comprises a device where data are located, the device comprising an initialization unit, a boot control unit, an environmental factor acquisition unit and an encryption and decryption unit, wherein
in an initialization process of the device, the initialization unit acquires an environmental factor according to the environment information of the device in a secure environment via the environmental factor acquiring unit, and encrypts sensitive data in the device via the encryption and decryption unit using the environmental factor; the initialization unit destroys the environmental factor after determining that the encryption succeeds;
every time the device is started, the boot control unit acquires an environmental factor according to the environment information of the device in the current environment via the environmental factor acquiring unit, and decrypts the encrypted sensitive data via the encryption and decryption unit using the environmental factor in the current environment; and the boot control unit allows access to the data in the device if the decryption succeeds, otherwise, it denies access to the data in the device.

9. According to the system of claim 8, wherein the system further comprises an environment information extraction unit,
the environment information extraction unit comprising at least one of: temperature collector extracting temperature environment information of the device, humidity collector extracting humidity environment information of the device, light collector extracting light environment information of the device, biometric collector extracting biometric information of the user of the device, image collector extracting physical environment image information of the device, network detection server extracting network environment information of the device, and authentication server extracting mutual identity authentication information of the device and the authentication server;
the environmental factor acquisition unit takes the environment information extracted by the environment information extraction unit as an environmental factor; or, generates an environmental factor using the environment information extracted by the environment information extraction unit.

10. According to the system of claim 8, wherein the system further comprises an environment monitoring server,
the environment monitoring server pre-collects the identity information of the device in a secure environment, and every time before the device is started, the environment monitoring server collects the identity information of the device in current environment, determines the identity information of the device in current environment according to the identity information of the device in a secure environment, and determines according to the determination result whether the device is a legal device; if it is, the device is allowed to access to a secure environment; and if not, the device is forbidden to access to a secure environment.
